(19) United States
(12) Patent Application Publication
(10) Pub. No.: US 2026/0210635 A1
(43) Pub. Date: Jul. 23, 2026

(54) SUPPLY DEVICE FOR SUPPLYING LIQUID WASTE TO LOW-TEMPERATURE MELTING FURNACE, AND SUPPLY METHOD USING SAME

(71) Applicant: KOREA HYDRO & NUCLEAR POWER CO., LTD, Gyeongju-si (KR)

(72) Inventors: Young Hwan HWANG, Daejeon (KR); Seok ju HWANG, Daejeon (KR); Mi Hyun LEE, Daejeon (KR); Cheon Woo KIM, Daejeon (KR)

(21) Appl. No.: 19/137,614

(22) PCT Filed: Feb. 1, 2024
(86) PCT No.: PCT/KR2024/001560

§ 371 Date: Jun. 10, 2025

(30) Foreign Application Priority Data
May 12, 2023 (KR) 10-2023-0061799

(51) Int. Cl. F27D 3/08; G21F 9/06

(52) U.S. Cl. CPC F27D 3/08; G21F 9/06

(57) ABSTRACT

The present invention relates to a supply device for supplying liquid waste to a low-temperature melting furnace. The supply device for supplying liquid waste to a low-temperature melting furnace comprises: a storage unit in which the liquid waste and a solvent are stored; a supply pipe through which the liquid waste and the solvent are supplied from the storage unit to a melting space in the low-temperature melting furnace; and a transfer unit which is at least partially located in the supply pipe and forcibly injects the liquid waste and solvent into the melting space via a spiral supply flow path.

### TECHNICAL FIELD

The present disclosure relates to a supply device for supplying liquid waste to a low-temperature melting furnace and a supply method using the same.

### BACKGROUND ART

Radioactive waste generated through nuclear power generation needs to be processed, stored, and managed more stably. Among the methods for processing and storing hazardous waste, low-temperature melting furnace vitrification technology has been developed.

The low-temperature melting furnace vitrification technology uses an induction heating low-temperature melting furnace to burn hazardous waste, melt heavy metals and vitrify the same into a glassy solid, trapping the same within a glass structure and isolating the same from leaching into the surrounding environment.

When a vitrification facility is operated for vitrification, waste (flammable solid waste, slurry, etc.) is fed into an upper portion of the melt through a waste supply pipe installed on an upper portion of the low-temperature melting furnace and is thermally decomposed.

In the case of feeding liquid waste into the vitrification facility (low-temperature melting furnace), in the past, a simple pipe-shaped feeding tube was used, making it difficult to quantify the waste. Furthermore, there were issues such as contamination diffusion and backflow.

### DETAILED DESCRIPTION OF INVENTION

### Technical Problems

An aspect of the present disclosure is directed to providing a supply device for supplying liquid waste to a low-temperature melting furnace and a supply method using the same.

### Technical Solution

An embodiment of the present disclosure relates to a supply device for supplying liquid waste to a low-temperature melting furnace. The supply device for supplying the liquid waste to the low-temperature melting furnace includes: a storage unit in which the liquid waste and a solvent are stored; a supply pipe through which the liquid waste and the solvent are supplied from the storage unit to a melting space in the low-temperature melting furnace; and a transfer unit which is at least partially located in the supply pipe and forcibly injects the liquid waste and the solvent into the melting space via a spiral supply flow path.

The storage unit may include: a first storage tank in which the liquid waste is stored; and a second storage tank which is separated from the first storage tank and in which the solvent is stored.

There may be further included an adjustment member which independently adjusts inflow amounts of the liquid waste and the solvent flowing into the supply pipe from the storage unit.

The transfer unit may include a rotatable screw, wherein the screw may prevent backflow of the liquid waste vaporized in the melting space.

The transfer unit may further include a central axis, the screw may be connected to the central axis, and an outer diameter of a blade of the screw may be 95% to 100% of an inner diameter of the supply pipe.

An embodiment of the present disclosure relates to a supply method for supplying liquid waste to a low-temperature melting furnace.

The supply method for supplying the liquid waste to the low-temperature melting furnace includes: supplying the liquid waste to a melting space of the low-temperature melting furnace through a supply pipe using a transfer unit including a spiral structure; melting the supplied liquid waste in the melting space; discharging the molten liquid waste from the melting space; and decontaminating the supply pipe and the transfer unit by supplying a solvent after the discharge of the liquid waste.

### Effect of Invention

An embodiment of the present disclosure provides a supply device for supplying liquid waste to a low-temperature melting furnace and a supply method using the same.

### BRIEF DESCRIPTION OF THE DRAWING

FIG. 1 illustrates a supply device for supplying liquid waste to a low-temperature melting furnace according to an embodiment of the present disclosure.

FIG. 2 is a flowchart illustrating a supply method for supplying liquid waste to a low-temperature melting furnace according to an embodiment of the present disclosure.

### BEST MODE FOR CARRYING OUT THE INVENTION

Hereinafter, the present disclosure will be described in more detail with reference to the accompanying drawings.

The accompanying drawings are merely examples illustrated to more specifically explain the technical idea of the present disclosure, and accordingly, the idea of the present disclosure is not limited to the accompanying drawings. In addition, the accompanying drawings may be exaggerated in size and spacing to illustrate the relationships between the components.

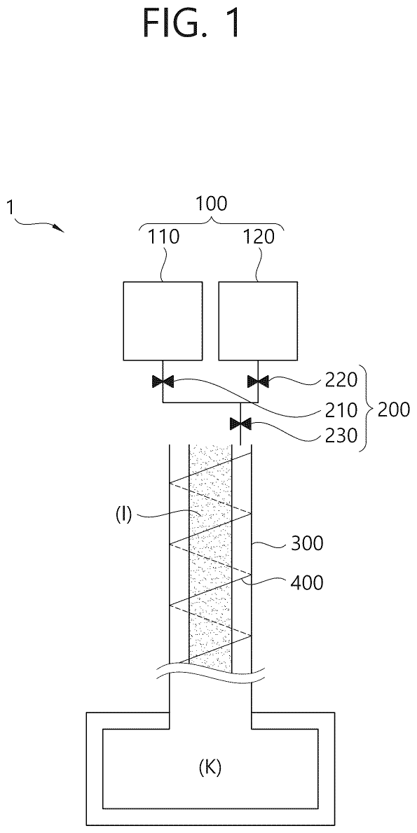

FIG. 1 illustrates a supply device for supplying liquid waste to a low-temperature melting furnace (hereinafter referred to as “supply device”) according to an embodiment of the present disclosure.

The low-temperature melting furnace of an embodiment of the present disclosure refers to a low-temperature melting furnace of a vitrification facility for processing radioactive waste (liquid waste or solid waste) in a nuclear power plant, but is not limited thereto.

A supply device 1 includes a storage unit 100, an adjustment member 200, a supply pipe 300, and a transfer unit 400.

The storage unit 100 stores the liquid waste and a solvent, and includes a first storage tank 110 and a second storage tank 120.

The first storage tank 110 stores the liquid waste. The first storage tank 110 may be filled with the liquid waste to a set capacity, but is not limited thereto. In another embodiment, the first storage tank 110 may be filled with melting target materials such as radioactive waste, general industrial waste, ceramic materials, and metal materials.

Referring to FIG. 1, the first storage tank 110 is illustrated in a tank shape, but is not limited thereto. In another embodiment, the first storage tank 110 may be provided in a conventional structure.

Although not shown, a separate device such as a pump may be further installed to ensure that the liquid waste in the first storage tank 110 flows smoothly into the supply pipe 300.

The second storage tank 120 is separated from the first storage tank 110 and stores the solvent. The second storage tank 120 may be filled with the solvent to a set capacity, and the second storage tank 120 may be provided in a conventional structure.

In this embodiment, the solvent stored in the second storage tank 120 may be a general-purpose solvent used to decontaminate components in contact with the liquid waste.

Although not shown, a separate device such as a pump may be further installed to ensure that the solvent in the second storage tank 120 flows smoothly into the supply pipe 300.

Referring to FIG. 1, the adjustment member 200 independently adjusts inflow amounts of the liquid waste and the solvent flowing into the supply pipe 300 from the storage unit 100. In particular, since the mixing ratio of the liquid waste and the solvent may be adjusted through the adjustment member 200, the liquid waste and solvent supplied to a melting space K through the supply pipe 300 may be supplied more efficiently.

Referring to FIG. 1, the adjustment member 200 is illustrated as being located within a separate pipe connected between the storage unit 100 and the supply pipe 300, but is not limited thereto. In another embodiment, the adjustment member 200 may be installed in a form in which at least a portion thereof is coupled to the storage unit 100.

The adjustment member 200 includes a first adjustment member 210, a second adjustment member 220, and a third adjustment member 230.

The first adjustment member 210 adjusts the inflow amount of the liquid waste discharged from the first storage tank 110.

Referring to FIG. 1, the first adjustment member 210 may be installed in a valve-like shape, but is not limited thereto. Herein, the inflow amount of the liquid waste supplied to the supply pipe 300 from the first storage tank 110 may be adjusted by opening and closing a valve.

The second adjustment member 220 adjusts the inflow amount of the solvent discharged from the second storage tank 120.

Referring to FIG. 1, the second adjustment member 220 may be installed in a valve-like shape, but is not limited thereto. Herein, the inflow amount of the solvent supplied to the supply pipe 300 from the second storage tank 120 may be adjusted by opening and closing the valve.

The third adjustment member 230 adjusts the inflow amount of a mixture of the liquid waste and the solvent flowing into the supply pipe 300.

Referring to FIG. 1, the third adjustment member 230 may be installed in a valve-like shape, but is not limited thereto. Herein, the inflow amount of a mixture of the liquid waste and the solvent supplied to the supply pipe 300 from the first storage tank 110 and the second storage tank 120 may be adjusted by opening and closing the valve.

The liquid waste and the solvent are supplied from the supply pipe 300 and the storage unit 100 to the melting space K of the low-temperature melting furnace.

In this embodiment, the low-temperature melting furnace for melting the liquid waste is not limited to a specific type.

Referring to FIG. 1, the supply pipe 300 is illustrated as being formed as a straight pipe overall, but is not limited thereto. In another embodiment, the supply pipe 300 may be of various shapes that may facilitate the injection of the liquid waste and the solvent, and may be made of a flexible material.

Although not shown, the supply pipe 300 may further include a heat source device (for example, a heater) surrounding at least a portion thereof to facilitate the flow of the liquid waste and the solvent passing through the supply pipe 300.

The transfer unit 400 is located at least partially within the supply pipe 300 and forcibly injects the liquid waste and the solvent into the melting space K through a spiral supply flow path.

The transfer unit 400 includes a rotatable screw and prevents the backflow of the liquid waste vaporized in the melting space K.

The screw is a hollow tube that is elongated overall, and although not shown, may further include a screw body having a blade of the screw formed on the outside and a screw extension extending from the screw body and having no blade of the screw formed thereon.

The blade of the screw may be provided in various shapes, such as continuously formed or intermittently formed.

The transfer unit 400 further includes a central axis I, the screw is connected to the central axis I, and an outer diameter of the blade of the screw may be 80% to 100%, 85% to 100%, and 90% to 100% of an inner diameter of the supply pipe, and suitably 95% to 100%.

By rotating the central axis I connected to the screw, the entire screw is rotated, and by the rotation of the screw, the liquid waste is efficiently supplied to the melting space K.

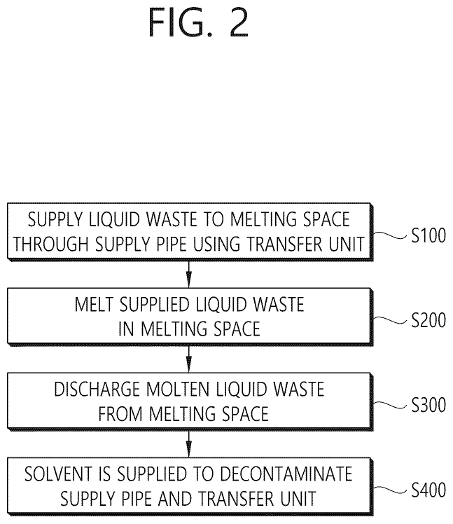

A supply method for supplying liquid waste to a low-temperature melting furnace using the supply device of an embodiment of the present disclosure is described with reference to FIG. 2.

FIG. 2 is a flowchart illustrating a supply method for supplying liquid waste to a low-temperature melting furnace according to an embodiment of the present disclosure.

First, the liquid waste is supplied to the melting space K of the low-temperature melting furnace through the supply pipe 300 using the transfer unit 400 including a spiral structure (S100).

When the liquid waste flows from the first storage tank 110 into the supply pipe 300, the liquid waste is supplied to the melting space K of the final low-temperature melting furnace through the transfer unit 400. Herein, the liquid waste is supplied by forced injection from the first storage tank 110 through the transfer unit 400 in the supply pipe 300.

Specifically, the liquid waste supplied to the supply pipe 300 is efficiently supplied to the melting space K through the rotating screw connected to the central axis I.

Due to the efficient supply of the liquid waste through the screw, various issues (blockage of waste in a pipe, volatilization, scattering, etc.) that occurred when conventional waste was input may be greatly lessened, and melting processing through the melting space K may be stably performed. In addition, the screw may have a positive influence on the efficient injection of the liquid waste and also helps in the decontamination of the supply pipe 300 and the transfer unit 400.

In this connection, the inflow amount of the liquid waste is adjusted through the adjustment member 200. In particular, the inflow amount of the liquid waste supplied form the first storage tank 110 to the supply pipe 300 is appropriately adjusted through the first adjustment member 210.

Thereafter, the supplied liquid waste is melted in the melting space K (S200). In this connection, in the case of the liquid waste vaporized by melting in the melting space K, backflow is prevented by the transfer unit 400.

Next, the molten liquid waste is discharged from the melting space K (S300).

Although not shown, a separate device may be further installed to post-process the molten liquid waste discharged from the melting space K, and through such post-processing, the volatilization of hazardous substances and radionuclides generated during the thermal decomposition process of the waste may be reduced.

Finally, after the discharge of the liquid waste, the solvent is supplied to decontaminate the supply pipe 300 and the transfer unit 400 (S400). Herein, the solvent is supplied by forced injection from the second storage tank 120 through the transfer unit 400 in the supply pipe 300.

Specifically, the solvent supplied to the supply pipe 300 and the transfer unit 400 performs decontamination of hazardous substances and radionuclides remaining in accordance with the supply of the liquid waste, thereby minimizing the amount of radioactive leakage of waste discharged to the outside.

In this embodiment, the solvent is supplied after the molten liquid waste is discharged from the melting space K, but is not limited thereto. In another embodiment, the solvent may be supplied simultaneously with the liquid waste to decontaminate the supply pipe 300 and the transfer unit 400.

The aforementioned embodiments are provided as examples to explain the present disclosure, and the present disclosure is not limited thereto. Since a person having ordinary skill in the technical field to which the present disclosure pertains will be able to implement the present disclosure by making various modifications therefrom, the technical protection scope of the present disclosure should be defined by the appended claims.

1. A supply device for supplying liquid waste to a low-temperature melting furnace, the supply device comprising:
a storage unit in which the liquid waste and a solvent are stored;
a supply pipe through which the liquid waste and the solvent are supplied from the storage unit to a melting space in the low-temperature melting furnace; and
a transfer unit which is at least partially located in the supply pipe and forcibly injects the liquid waste and the solvent into the melting space via a spiral supply flow path.

2. The supply device of claim 1, wherein the storage unit comprises:
a first storage tank in which the liquid waste is stored; and
a second storage tank which is separated from the first storage tank and in which the solvent is stored.

3. The supply device of claim 2, further comprising an adjustment member which independently adjusts inflow amounts of the liquid waste and the solvent flowing into the supply pipe from the storage unit.

4. The supply device of claim 1, wherein the transfer unit comprises a rotatable screw, wherein the screw prevents backflow of the liquid waste vaporized in the melting space.

5. The supply device of claim 4, wherein:
the transfer unit further comprises a central axis;
the screw is connected to the central axis; and
an outer diameter of a blade of the screw is 95% to 100% of an inner diameter of the supply pipe.

6. A supply method for supplying liquid waste to a low-temperature melting furnace, the supply method comprising:
supplying the liquid waste to a melting space of the low-temperature melting furnace through a supply pipe using a transfer unit comprising a spiral structure;
melting the supplied liquid waste in the melting space;
discharging the molten liquid waste from the melting space; and
decontaminating the supply pipe and the transfer unit by supplying a solvent after the discharge of the liquid waste.
